(19) United States
(12) Patent Application Publication
(10) Pub. No.: US 2026/0148707 A1
(43) Pub. Date: May 28, 2026

(54) BIDIRECTIONAL ADDRESS ALLOCATION METHOD AND SYSTEM

(71) Applicants: Huayuan Semiconductor (Shenzhen) Limited Company, Shenzhen (CN); Huayuan Semiconductor (Tianjin) Limited Company, Tianjin (CN)

(72) Inventors: Honglai WANG, Tianjin (CN); Yujun WANG, Tianjin (CN); Yuting FANG, Tianjin (CN); Yufeng ZOU, Tianjin (CN)

(73) Assignees: Huayuan Semiconductor (Shenzhen) Limited Company, Shenzhen (CN); Huayuan Semiconductor (Tianjin) Limited Company, Tianjin (CN)

(21) Appl. No.: 19/454,370

(22) Filed: Jan. 20, 2026

Related U.S. Application Data
(63) Continuation of application No. PCT/CN2024/115605, filed on Aug. 29, 2024.

(30) Foreign Application Priority Data
Nov. 14, 2023 (CN) 2023115139355

(51) Int. Cl. G09G 3/34

(52) U.S. Cl. CPC G09G 3/3406; G09G 2330/08; G09G 2370/00

(57) ABSTRACT

A bidirectional address allocation method and system are used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction from a unit awaiting address allocation connected to the second serial data port of the controller is a reverse direction. The method includes: performing forward address allocation; determining whether address allocation for the N units awaiting address allocation is completed; changing an input/output direction; and performing reverse address allocation.

### TECHNICAL FIELD

The present invention relates to the field of communications technologies, and in particular, to a bidirectional address allocation method and system.

### BACKGROUND

With development of a display technology, an LED array light source has been increasingly used in a liquid crystal display system. In addition, as a mini-LED technology is improved, a yield is increased, and costs are reduced, a quantity of partitions in a backlight system of a display system is becoming larger, which progressively increases from hundreds to thousands or even tens of thousands. To precisely control brightness of beads in these partitions, several LED driver chips need to be connected in series to adjust a magnitude of a current in and a duty cycle of the LED beads. Allocating an independent address to each driver chip is the first step for data communication.

FIG. 1 and FIG. 2 show the most commonly used address allocation methods in the conventional technology. A controller is responsible for overall system control, including configuration for an address of the driver chip, dimming data transmission, reading a status of the driver chip, and another operation. DIS and DOS are input and output terminals of the driver chip, and a direction of an arrow is a direction of signal transmission.

In FIG. 1, after power-on, each driver chip has a default ID value of 0. In FIG. 2, the controller sends an address allocation command through the DIS terminal to CHIP1. CHIP1 increases an address of CHIP1 by 1, then sends the address allocation command through DOS of CHIP1 to a DIS terminal of CHIP2. This process continues until address allocation for CHIP6 is completed, after which the address allocation command is transmitted back to the controller, thereby completing the entire address allocation process.

The foregoing address allocation solution has the following problem: if one of the chips is faulty, such as a chip pin being open, shorted, or the chip being damaged, then address allocation cannot be performed on the current chip and a subsequent chip. After a control system sends dimming data, these chips each have an address of 0, and cannot control corresponding LED beads. As shown in FIG. 3, if CHIP4 is faulty, only CHIP1 to CHIP3 complete an address allocation operation, while CHIP4 to CHIP6 remain in an ID=0 state. A solid arrow in the figure indicates that a communication signal can be transmitted further, while a dashed arrow indicates that the communication signal cannot be transmitted further.

### SUMMARY

The present invention provides a bidirectional address allocation method and system, so as to resolve a problem existing in the conventional technology that when a chip is faulty, address allocation cannot be performed on the current chip and a subsequent chip.

To resolve the foregoing technical problem, the present invention is implemented by using the following technical solutions:
According to a first aspect of the present invention, a bidirectional address allocation method is provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

The bidirectional address allocation method includes:
performing forward address allocation: allocating independent addresses sequentially and serially to the units awaiting address allocation of the at least one module awaiting address allocation in the forward direction through the first serial data port of the controller;
determining whether address allocation for the N units awaiting address allocation is completed: determining whether the second serial data port of the controller reads back address information of a last unit awaiting address allocation within a preset time, and if yes, completing address allocation, or if no, proceeding to a next step;
changing an input/output direction: changing input/output directions of the first serial data port of the controller, the second serial data port of the controller, and the two serial data ports of the unit awaiting address allocation; and
performing reverse address allocation: allocating independent addresses sequentially and serially to the units awaiting address allocation of the at least one module awaiting address allocation in the reverse direction through the second serial data port of the controller.

Preferably, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

According to a second aspect of the present invention, a bidirectional address allocation method is provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

The bidirectional address allocation method includes:
performing reverse address allocation: allocating independent addresses sequentially and serially to the units awaiting address allocation of the at least one module awaiting address allocation in the reverse direction through the second serial data port of the controller;
determining whether address allocation for the N units awaiting address allocation is completed: determining whether the first serial data port of the controller reads back address information of a first unit awaiting address allocation within a preset time, and if yes, completing address allocation, or if no, proceeding to a next step;
changing an input/output direction: changing input/output directions of the first serial data port of the controller, the second serial data port of the controller, and the two serial data ports of the unit awaiting address allocation; and
performing forward address allocation: allocating independent addresses sequentially and serially to the units awaiting address allocation of the at least one module awaiting address allocation in the forward direction through the first serial data port of the controller.

Preferably, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

According to a third aspect of the present invention, a bidirectional address allocation method is provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

The bidirectional address allocation method includes:
performing forward address allocation: allocating independent addresses sequentially and serially to the units awaiting address allocation of the at least one module awaiting address allocation in the forward direction through the first serial data port of the controller;
changing an input/output direction: after a preset time, changing input/output directions of the first serial data port of the controller, the second serial data port of the controller, and the two serial data ports of the unit awaiting address allocation; and
performing reverse address allocation: allocating independent addresses sequentially and serially to the units awaiting address allocation of the at least one module awaiting address allocation in the reverse direction through the second serial data port of the controller.

Preferably, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

According to a fourth aspect of the present invention, a bidirectional address allocation method is provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

The bidirectional address allocation method includes:
performing reverse address allocation: allocating independent addresses sequentially to the units awaiting address allocation of the at least one module awaiting address allocation in the reverse direction through the second serial data port of the controller;
changing an input/output direction: after a preset time, changing input/output directions of the first serial data port of the controller, the second serial data port of the controller, and the two serial data ports of the unit awaiting address allocation; and
performing forward address allocation: allocating independent addresses sequentially to the units awaiting address allocation of the at least one module awaiting address allocation in the forward direction through the first serial data port of the controller.

Preferably, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

According to a fifth aspect of the present invention, a bidirectional address allocation system is provided. The bidirectional address allocation system is configured to allocate independent addresses to N units awaiting address allocation of at least one module awaiting address allocation.

The bidirectional address allocation system includes a controller.

The controller includes a first serial data port of the controller and a second serial data port of the controller.

The first serial data port of the controller, two serial data ports of each of the N units awaiting address allocation, and the second serial data port of the controller are sequentially connected in series.

The first serial data port of the controller, the two serial data ports of each of the N units awaiting address allocation, and the second serial data port of the controller are configured such that: an input/output direction is changeable.

The controller is configured to allocate independent addresses sequentially and serially to the units awaiting address allocation of the at least one module awaiting address allocation in a forward direction through the first serial data port of the controller, and is further configured to allocate independent addresses sequentially and serially to the units awaiting address allocation of the at least one module awaiting address allocation in a reverse direction through the second serial data port of the controller.

In the module awaiting address allocation, a direction starting from a unit awaiting address allocation connected to the first serial data port of the controller is the forward direction, and a direction starting from a unit awaiting address allocation connected to the second serial data port of the controller is the reverse direction.

Preferably, the controller further includes a parallel data port.

The parallel data port is connected in parallel to each of the N units awaiting address allocation.

The controller is further configured to change input/output directions of the first serial data port of the controller and the second serial data port of the controller, and send a broadcast command to each of the N units awaiting address allocation through the parallel data port to change input/output directions of the two serial data ports of the unit awaiting address allocation.

Preferably, the unit awaiting address allocation is a display driver unit.

According to the bidirectional address allocation method and system provided in the present invention, the input/output directions of the first serial data port of the controller, the second serial data port of the controller, and the two serial data ports of the unit awaiting address allocation are changeable. Independent addresses may be allocated sequentially in the forward direction or may be allocated sequentially in the reverse direction to the units awaiting address allocation of the at least one module awaiting address allocation. When a unit awaiting address allocation experiences a fault, after two address allocation operations, namely, forward address allocation and reverse address allocation, are performed, except for address allocation not being completed for the unit awaiting address allocation that has experienced a fault, address allocation is completed for the other units awaiting address allocation, and the controller can normally control the units awaiting address allocation.

In an optional solution of the present invention, the parallel data port is disposed, and a broadcast command is sent through the parallel data port to change the input/output directions of the two serial data ports of the unit awaiting address allocation, which makes implementation simple, convenient, and fast.

### BRIEF DESCRIPTION OF DRAWINGS

To describe the technical solutions in embodiments of the present invention or the conventional technology more clearly, the following briefly describes the accompanying drawings required for describing the embodiments or the conventional technology. It is clear that, the accompanying drawings in the following description show only some embodiments of the present invention, and a person of ordinary skill in the art may still derive other drawings from these accompanying drawings without creative efforts.

FIG. 1 is a schematic diagram in which all driver chips have a default ID of 0 after power-on in the conventional technology;

FIG. 2 is a schematic diagram in which address allocation is completed after a controller sends an address allocation command in the conventional technology;

FIG. 3 is a schematic diagram of a case where address allocation is completed when one driver chip (CHIP4) is faulty in the conventional technology;

FIG. 4 is a schematic diagram of a bidirectional address allocation system according to an embodiment of the present invention;

FIG. 5 is a schematic diagram of a forward address allocation process of a bidirectional address allocation system according to an embodiment of the present invention;

FIG. 6 is a schematic diagram of a reverse address allocation process of a bidirectional address allocation system according to an embodiment of the present invention;

FIG. 7 is a schematic diagram of a case where a forward address allocation is completed when one unit awaiting address allocation (CHIP4) is faulty according to an embodiment of the present invention;

FIG. 8 is a schematic diagram of a case where address allocation is completed when one unit awaiting address allocation (CHIP4) is faulty according to an embodiment of the present invention;

FIG. 9 is a schematic diagram of a bidirectional address allocation system according to another embodiment of the present invention;

FIG. 10 is a flowchart of a bidirectional address allocation method according to an embodiment of the present invention;

FIG. 11 is a flowchart of a bidirectional address allocation method according to another embodiment of the present invention;

FIG. 12 is a flowchart of a bidirectional address allocation method according to another embodiment of the present invention; and

FIG. 13 is a flowchart of a bidirectional address allocation method according to another embodiment of the present invention.
1—Controller,
2—Module awaiting address allocation.
21—Unit awaiting address allocation.

### DESCRIPTION OF EMBODIMENTS

The technical solutions of the embodiments of the present invention are clearly and completely described below with reference to the accompanying drawings in the embodiments of the present invention. Apparently, the described embodiments are merely some rather than all of the embodiments of the present invention. Based on the embodiments of the present invention, all other embodiments obtained by those of ordinary skill in the art without creative efforts should fall within the protection scope of the present invention.

In the description of the specification of the present invention, it should be noted that an orientation or positional relationship indicated by terms “upper part”, “lower part”, “upper end”, “lower end”, “lower surface”, “upper surface”, and the like is based on an orientation or positional relationship shown in the accompanying drawings, and is only for the convenience of describing the present invention and simplifying the description, rather than indicating or implying that the indicated apparatus or component must have a specific orientation or must be constructed and operated in a specific orientation. Therefore, the orientation or positional relationship should not be construed as a limitation on the present invention.

In the description of the specification of the present invention, terms “first” and “second” are used for descriptive purposes only and should not be construed as indicating or implying relative importance or implicitly indicating a quantity of indicated technical features. Therefore, a feature defined by “first” or “second” may explicitly or implicitly include one or more such features.

In the descriptions of the present invention, unless otherwise specifically defined, “a plurality of” means two or more, for example, two, three, four, or the like.

In the descriptions of the present invention, unless otherwise clearly specified and limited, terms such as “connection” are intended to be understood in a broad sense. For example, the “connection” may be a fixed connection, a removable connection, or an integral connection; may be a mechanical connection or an electrical connection, or may be communication with each other; may be a direct connection or an indirect connection via a medium; or may be communication inside two elements or an interactive relationship between two elements. A person of ordinary skill in the art may understand specific meanings of the foregoing terms in the present invention based on specific cases.

The technical solutions provided in the present invention are described below in detail by using specific embodiments. The following specific embodiments may be combined with each other, and details of the same or similar concepts or processes may not be repeated in some embodiments.

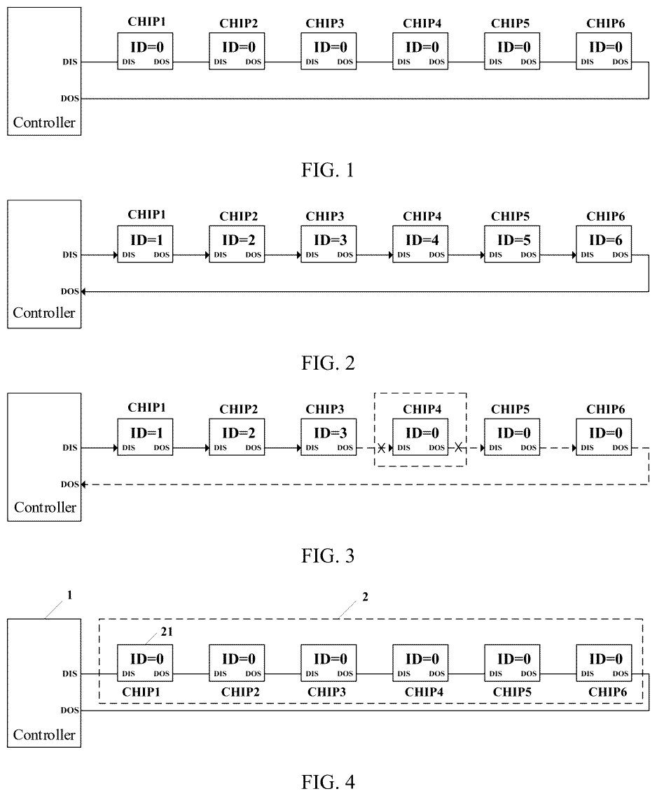

In an embodiment, a bidirectional address allocation system is provided. The bidirectional address allocation system is: being used to allocate independent addresses to N units awaiting address allocation 21 of at least one module awaiting address allocation 2. Referring to FIG. 4, the bidirectional address allocation system includes a controller 1. The controller includes a first serial data port (DIS) of the controller and a second serial data port (DOS) of the controller. The first serial data port of the controller, two serial data ports (DIS and DOS) of each of the N units awaiting address allocation 21 (for example, six (CHIP1-CHIP6) in FIG. 1), and the second serial data port of the controller are sequentially connected in series.

The first serial data port of the controller, the two serial data ports of each of the N units awaiting address allocation, and the second serial data port of the controller are configured such that: An input/output direction is changeable. Refer to FIG. 6 for one direction, and FIG. 7 for another direction. The controller is configured to allocate independent addresses sequentially and serially to the units awaiting address allocation of the at least one module awaiting address allocation in a forward direction through the first serial data port of the controller, and is further configured to allocate independent addresses sequentially and serially to the units awaiting address allocation of the at least one module awaiting address allocation in a reverse direction through the second serial data port of the controller. In the module awaiting address allocation, a direction starting from a unit awaiting address allocation connected to the first serial data port of the controller is the forward direction (that is, from left to right in FIG. 4), and a direction starting from a unit awaiting address allocation connected to the second serial data port of the controller is the reverse direction (that is, from right to left in FIG. 4).

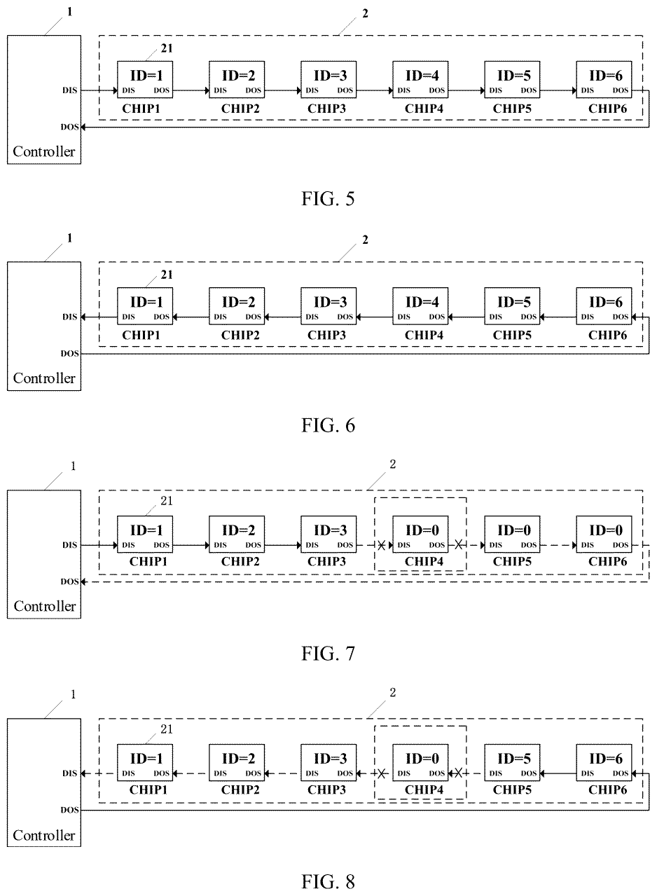

A working principle of the bidirectional address allocation system in the foregoing embodiment is as follows: After power-on, initial IDs of the units awaiting address allocation are all 0, with reference to FIG. 4. For a forward address allocation process, refer to FIG. 5. The controller 1 sends an address allocation command to a first unit awaiting address allocation CHIP1 through the first serial data port of the controller. CHIP1 increases an address of CHIP1 by 1, and then sends the address allocation command to a serial data port (DIS) of CHIP2 through a serial data port (DOS) of CHIP1. CHIP2 increases received address information by 1 to set as an address of CHIP2. This process continues until address allocation for CHIP6 is completed. For reverse address allocation, refer to FIG. 6. The controller 1 sends an address allocation command to a last unit awaiting address allocation CHIP6 through the second serial data port of the controller, thereby configuring an address of CHIP6 as 6. Then, a serial data port (DIS) of CHIP6 sends the address allocation command to a serial data port (DOS) of CHIP5. CHIP5 decreases currently received address information by 1 to set as an address of CHIP5. Address allocation is performed sequentially from back to front. When one chip is faulty (for example, CHIP4 is faulty), after forward address allocation is performed, address allocation is completed for CHIP1 to CHIP3, with reference to FIG. 7. After reverse address allocation is performed, address allocation is completed for CHIP5 and CHIP6, with reference to FIG. 8. Through these two address allocation operations, address allocation is completed for all chips except for CHIP4, and the controller can normally control chips. In other words, an objective of the controller to control all chips, except for the faulty CHIP4, is achieved.

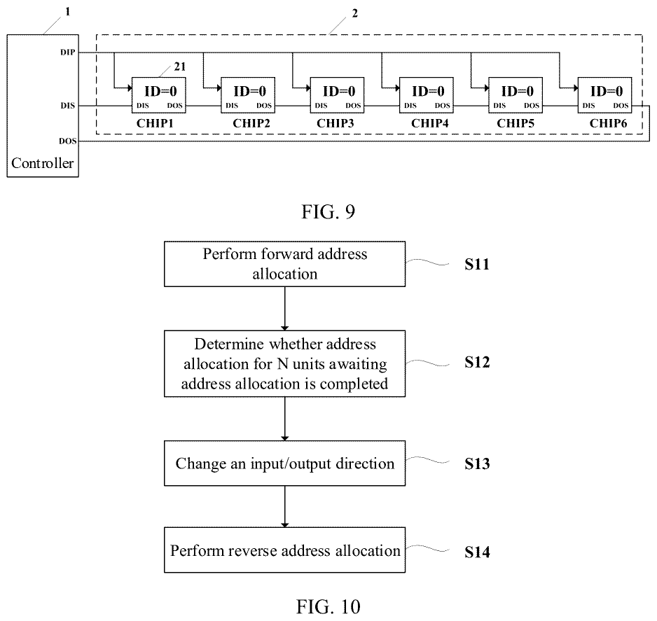

In an embodiment, the controller further includes a parallel data port (DIP). The parallel data port is connected in parallel to each of the N units awaiting address allocation, with reference to FIG. 9. The controller is further configured to change input/output directions of the first serial data port of the controller and the second serial data port of the controller, and send a broadcast command to each of the N units awaiting address allocation through the parallel data port to change input/output directions of the two serial data ports of each of the N units awaiting address allocation.

In an embodiment, the unit awaiting address allocation is a display driver unit, for example, may be an LED driver unit.

In an embodiment, a bidirectional address allocation method is provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

Referring to FIG. 10, the bidirectional address allocation method includes the following steps.

S11: Perform forward address allocation: allocate independent addresses sequentially and serially to units awaiting address allocation of at least one module awaiting address allocation in a forward direction through a first serial data port of a controller.

Specifically, an address allocation command is sent to one serial data port of a first unit awaiting address allocation through the first serial data port of the controller. The first unit awaiting address allocation increases an address by 1, and sends the address allocation command to one serial data port of a second unit awaiting address allocation through the other serial data port of the first unit awaiting address allocation. The second unit awaiting address allocation increases received address information by 1 to set as an address of the second unit awaiting address allocation. A subsequent process follows the same pattern, until address allocation is completed for a last unit awaiting address allocation.

S12: Determine whether address allocation for the N units awaiting address allocation is completed: determine whether a second serial data port of the controller reads back address information of a last unit awaiting address allocation within a preset time, and if yes, complete address allocation, or if no, proceed to S13.

S13: Change an input/output direction: change input/output directions of the first serial data port of the controller, the second serial data port of the controller, and two serial data ports of each of the units awaiting address allocation.

S14: Perform reverse address allocation: allocate independent addresses sequentially and serially to the units awaiting address allocation of the at least one module awaiting address allocation in a reverse direction through the second serial data port of the controller.

Specifically, an address allocation command is sent to one serial data port of the last unit awaiting address allocation (assuming there are N units awaiting address allocation) through the second serial data port of the controller, to configure an address of the last unit awaiting address allocation as n. Then, the address allocation command is sent to a serial data port of a penultimate unit awaiting address allocation through the other serial data port of the last unit awaiting address allocation. The penultimate unit awaiting address allocation decreases received address information by 1 to set as an address of the penultimate unit awaiting address allocation. A subsequent process follows the same pattern, until address allocation is completed for the first unit awaiting address allocation.

In the foregoing embodiment, forward address allocation is performed first. If address allocation is completed for all units awaiting address allocation after forward address allocation is completed, it is indicated that all units awaiting address allocation are normal, then reverse address allocation is not performed. If address allocation is completed for not all units awaiting address allocation after forward address allocation is completed, then reverse address allocation is performed.

In an embodiment, the changing an input/output direction specifically includes: sending a broadcast command to the unit awaiting address allocation through a parallel data port, so as to change the input/output directions of the two serial data ports of the unit awaiting address allocation.

In an embodiment, a bidirectional address allocation method is further provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

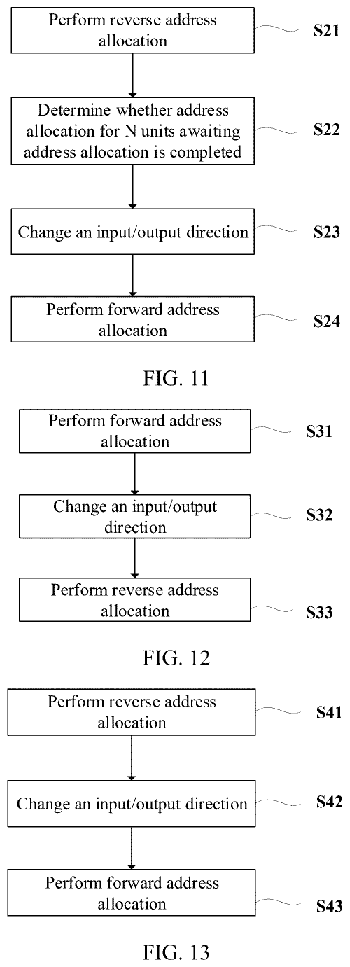

Referring to FIG. 11, the bidirectional address allocation method includes the following steps.

S21: Perform reverse address allocation: allocate independent addresses sequentially and serially to units awaiting address allocation of at least one module awaiting address allocation in a reverse direction through a second serial data port of a controller.

S22: Determine whether address allocation for the N units awaiting address allocation is completed: determine whether a first serial data port of the controller reads back address information of a first unit awaiting address allocation within a preset time, and if yes, complete address allocation, or if no, proceed to S23.

S23: Change an input/output direction: change input/output directions of the first serial data port of the controller, the second serial data port of the controller, and two serial data ports of each of the units awaiting address allocation.

S24: Perform forward address allocation: allocate independent addresses sequentially and serially to the units awaiting address allocation of the at least one module awaiting address allocation in a forward direction through the first serial data port of the controller.

In the foregoing embodiment, reverse address allocation is performed first. If address allocation is completed for all units awaiting address allocation after reverse address allocation is completed, it is indicated that all units awaiting address allocation are normal, then forward address allocation is not performed. If address allocation is completed for not all units awaiting address allocation after reverse address allocation is completed, then forward address allocation is performed.

In an embodiment, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

In an embodiment, a bidirectional address allocation method is further provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

Referring to FIG. 12, the bidirectional address allocation method includes the following steps.

S31: Perform forward address allocation: allocate independent addresses sequentially and serially to units awaiting address allocation of at least one module awaiting address allocation in a forward direction through a first serial data port of a controller.

S32: Change an input/output direction: after a preset time, change input/output directions of the first serial data port of the controller, a second serial data port of the controller, and two serial data ports of each of the units awaiting address allocation.

S33: Perform reverse address allocation: allocate independent addresses sequentially and serially to the units awaiting address allocation of the at least one module awaiting address allocation in a reverse direction through the second serial data port of the controller.

In the foregoing embodiment, forward address allocation is performed first. After forward address allocation is completed, regardless of whether address allocation is completed for all units awaiting address allocation, reverse address allocation is subsequently performed following a preset time.

In an embodiment, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

In an embodiment, a bidirectional address allocation method is further provided. The bidirectional address allocation method is a method used for allocating independent addresses to N units awaiting address allocation of at least one module awaiting address allocation. A first serial data port of a controller, two serial data ports of each of the N units awaiting address allocation, and a second serial data port of the controller are sequentially connected in series. In the module awaiting address allocation, a direction starting from a unit awaiting address allocation connected to the first serial data port of the controller is a forward direction, and a direction starting from a unit awaiting address allocation connected to the second serial data port of the controller is a reverse direction.

Referring to FIG. 13, the bidirectional address allocation method includes the following steps.

S41: Perform reverse address allocation: allocate independent addresses sequentially and serially to units awaiting address allocation of at least one module awaiting address allocation in a reverse direction through a second serial data port of a controller.

S42: Change an input/output direction: after a preset time, change input/output directions of a first serial data port of the controller, the second serial data port of the controller, and two serial data ports of each of the units awaiting address allocation.

S43: Perform forward address allocation: allocate independent addresses sequentially and serially to the units awaiting address allocation of the at least one module awaiting address allocation in a forward direction through the first serial data port of the controller.

In the foregoing embodiment, reverse address allocation is performed first. After reverse address allocation is completed, regardless of whether address allocation is completed for all units awaiting address allocation, forward address allocation is subsequently performed following a preset time.

In an embodiment, the changing input/output directions of the two serial data ports of the unit awaiting address allocation specifically includes: sending a broadcast command to the unit awaiting address allocation through a parallel data port, so as to change the input/output directions of the two serial data ports of the unit awaiting address allocation.

In the description of this specification, a reference to the descriptions of terms such as “an implementation”, “an embodiment”, “a specific implementation process” and “an example” means that specific features, structures, materials, or features described with reference to this embodiment or example are included in at least one embodiment or example of the present invention. In this specification, schematic descriptions of the above terms do not necessarily refer to a same embodiment or example. In addition, specific features, structures, materials, or characteristics described may be properly combined in any one or more embodiments or examples.

Finally, it should be noted that the foregoing embodiments are merely used to describe but not limit the technical solutions of the present invention. Although the present invention is described in detail with reference to the foregoing embodiments, it should be understood by a person of ordinary skill in the art that the technical solutions described in the foregoing embodiments may still be modified, or some or all technical features thereof may be equivalently replaced. These modifications or replacements do not make the essence of the corresponding technical solutions depart from the scope of the technical solutions of the embodiments of the present invention.

1. A bidirectional address allocation method, wherein the method is a method used for allocating independent addresses to N units awaiting address allocation of at least one module awaiting address allocation, wherein a first serial data port of a controller, two serial data ports of each of the N units awaiting address allocation, and a second serial data port of the controller are sequentially connected in series, in the module awaiting address allocation, a direction starting from a unit awaiting address allocation connected to the first serial data port of the controller is a forward direction, and a direction starting from a unit awaiting address allocation connected to the second serial data port of the controller is a reverse direction; and
the bidirectional address allocation method comprises:
performing forward address allocation: allocating independent addresses sequentially and serially to the units awaiting address allocation of the at least one module awaiting address allocation in the forward direction through the first serial data port of the controller;
determining whether address allocation for the N units awaiting address allocation is completed: determining whether the second serial data port of the controller reads back address information of a last unit awaiting address allocation within a preset time, and if yes, completing address allocation, or if no, proceeding to a next step;
changing an input/output direction: changing input/output directions of the first serial data port of the controller, the second serial data port of the controller, and the two serial data ports of the unit awaiting address allocation; and
performing reverse address allocation: allocating independent addresses sequentially and serially to the units awaiting address allocation of the at least one module awaiting address allocation in the reverse direction through the second serial data port of the controller.

2. The bidirectional address allocation method according to claim 1, wherein the changing input/output directions of the two serial data ports of the unit awaiting address allocation specifically comprises: sending a broadcast command to each of the units awaiting address allocation through a parallel data port, so as to change the input/output directions of the two serial data ports of the unit awaiting address allocation.

3. A bidirectional address allocation method, wherein the method is a method used for allocating independent addresses to N units awaiting address allocation of at least one module awaiting address allocation, wherein a first serial data port of a controller, two serial data ports of each of the N units awaiting address allocation, and a second serial data port of the controller are sequentially connected in series, in the module awaiting address allocation, a direction starting from a unit awaiting address allocation connected to the first serial data port of the controller is a forward direction, and a direction starting from a unit awaiting address allocation connected to the second serial data port of the controller is a reverse direction; and
the bidirectional address allocation method comprises:
performing reverse address allocation: allocating independent addresses sequentially and serially to the units awaiting address allocation of the at least one module awaiting address allocation in the reverse direction through the second serial data port of the controller;
determining whether address allocation for the N units awaiting address allocation is completed: determining whether the first serial data port of the controller reads back address information of a first unit awaiting address allocation within a preset time, and if yes, completing address allocation, or if no, proceeding to a next step;
changing an input/output direction: changing input/output directions of the first serial data port of the controller, the second serial data port of the controller, and the two serial data ports of the unit awaiting address allocation; and
performing forward address allocation: allocating independent addresses sequentially and serially to the units awaiting address allocation of the at least one module awaiting address allocation in the forward direction through the first serial data port of the controller.

4. The bidirectional address allocation method according to claim 3, wherein the changing input/output directions of the two serial data ports of the unit awaiting address allocation specifically comprises: sending a broadcast command to the unit awaiting address allocation through a parallel data port, so as to change the input/output directions of the two serial data ports of the unit awaiting address allocation.

5. A bidirectional address allocation method, wherein the method is a method used for allocating independent addresses to N units awaiting address allocation of at least one module awaiting address allocation, wherein a first serial data port of a controller, two serial data ports of each of the N units awaiting address allocation, and a second serial data port of the controller are sequentially connected in series, in the module awaiting address allocation, a direction starting from a unit awaiting address allocation connected to the first serial data port of the controller is a forward direction, and a direction starting from a unit awaiting address allocation connected to the second serial data port of the controller is a reverse direction; and
the bidirectional address allocation method comprises:
performing forward address allocation: allocating independent addresses sequentially and serially to the units awaiting address allocation of the at least one module awaiting address allocation in the forward direction through the first serial data port of the controller;
changing an input/output direction: after a preset time, changing input/output directions of the first serial data port of the controller, the second serial data port of the controller, and the two serial data ports of the unit awaiting address allocation; and
performing reverse address allocation: allocating independent addresses sequentially and serially to the units awaiting address allocation of the at least one module awaiting address allocation in the reverse direction through the second serial data port of the controller.

6. The bidirectional address allocation method according to claim 5, wherein the changing input/output directions of the two serial data ports of the unit awaiting address allocation specifically comprises: sending a broadcast command to the unit awaiting address allocation through a parallel data port, so as to change the input/output directions of the two serial data ports of the unit awaiting address allocation.

7. A bidirectional address allocation method, wherein the method is a method used for allocating independent addresses to N units awaiting address allocation of at least one module awaiting address allocation, wherein a first serial data port of a controller, two serial data ports of each of the N units awaiting address allocation, and a second serial data port of the controller are sequentially connected in series, in the module awaiting address allocation, a direction starting from a unit awaiting address allocation connected to the first serial data port of the controller is a forward direction, and a direction starting from a unit awaiting address allocation connected to the second serial data port of the controller is a reverse direction; and
the bidirectional address allocation method comprises:
performing reverse address allocation: allocating independent addresses sequentially and serially to the units awaiting address allocation of the at least one module awaiting address allocation in the reverse direction through the second serial data port of the controller;
changing an input/output direction: after a preset time, changing input/output directions of the first serial data port of the controller, the second serial data port of the controller, and the two serial data ports of the unit awaiting address allocation; and
performing forward address allocation: allocating independent addresses sequentially and serially to the units awaiting address allocation of the at least one module awaiting address allocation in the forward direction through the first serial data port of the controller.

8. The bidirectional address allocation method according to claim 7, wherein the changing input/output directions of the two serial data ports of the unit awaiting address allocation specifically comprises: sending a broadcast command to the unit awaiting address allocation through a parallel data port, so as to change the input/output directions of the two serial data ports of the unit awaiting address allocation.

9. A bidirectional address allocation system, configured to allocate independent addresses to N units awaiting address allocation of at least one module awaiting address allocation; wherein
the bidirectional address allocation system comprises a controller;
the controller comprises a first serial data port of the controller and a second serial data port of the controller;
the first serial data port of the controller, two serial data ports of each of the N units awaiting address allocation, and the second serial data port of the controller are sequentially connected in series;
the first serial data port of the controller, the two serial data ports of each of the N units awaiting address allocation, and the second serial data port of the controller are configured such that: an input/output direction is changeable;
the controller is configured to allocate independent addresses sequentially and serially to the units awaiting address allocation of the at least one module awaiting address allocation in a forward direction through the first serial data port of the controller, and is further configured to allocate independent addresses sequentially and serially to the units awaiting address allocation of the at least one module awaiting address allocation in a reverse direction through the second serial data port of the controller; and
in the module awaiting address allocation, a direction starting from a unit awaiting address allocation connected to the first serial data port of the controller is the forward direction, and a direction starting from a unit awaiting address allocation connected to the second serial data port of the controller is the reverse direction.

10. The bidirectional address allocation system according to claim 9, wherein the controller further comprises a parallel data port;
the parallel data port is connected in parallel to each of the N units awaiting address allocation; and
the controller is further configured to change input/output directions of the first serial data port of the controller and the second serial data port of the controller, and send a broadcast command to each of the N units awaiting address allocation through the parallel data port to change input/output directions of the two serial data ports of the unit awaiting address allocation.

11. The bidirectional address allocation system according to claim 9, wherein the unit awaiting address allocation is a display driver unit.

12. The bidirectional address allocation system according to claim 10, wherein the unit awaiting address allocation is a display driver unit.
